(19) United States
(12) Patent Application Publication
(10) Pub. No.: US 2024/0397425 A1
(43) Pub. Date: Nov. 28, 2024

(54) WAKE-UP SIGNAL ASSOCIATED TO REGION TRANSMITTED TO TERMINAL DEVICE

(71) Applicant: Nokia Technologies Oy, Espoo (FI)

(72) Inventors: Srinivasan SELVAGANAPATHY, Bangalore (IN); Jeroen WIGARD, Aalborg (DK); Mads LAURIDSEN, Aalborg (DK); Rapeepat RATASUK, Naperville, IL (US)

(21) Appl. No.: 18/701,592

(22) PCT Filed: Oct. 5, 2022
(86) PCT No.: PCT/EP2022/077650

§ 371 Date: Apr. 15, 2024

(30) Foreign Application Priority Data
Oct. 29, 2021 (IN) 202141049530

(51) Int. Cl. H04W 52/02

(52) U.S. Cl. CPC H04W 52/0235

(57) ABSTRACT

An apparatus, comprising at least one processor, and at least one memory storing instructions, the at least one memory and the instructions configured to, with the at least one processor, cause a network device to transmit a first information characterizing a region associated with a wakeup signal to at least one terminal device.

### FIELD OF THE DISCLOSURE

Various example embodiments relate to an apparatus comprising at least one processor.

Further embodiments relate to a method of operating related to such apparatus.

### BACKGROUND

Wireless communications systems may e.g. be used for wireless exchange of information between two or more entities, e.g. comprising one or more terminal devices, e.g. user equipment, and one or more network devices such as e.g. base stations.

In some conventional systems, a wakeup signal may be transmitted to a terminal device, e.g. to wake the terminal device from an idle state with comparatively low energy consumption.

### SUMMARY

Various embodiments of the disclosure are set out by the independent claims. The exemplary embodiments and features, if any, described in this specification, that do not fall under the scope of the independent claims, are to be interpreted as examples useful for understanding various exemplary embodiments of the disclosure.

Some embodiments relate to an apparatus, comprising at least one processor, and at least one memory storing instructions, the at least one memory and the instructions configured to, with the at least one processor, cause a network device to transmit a first information characterizing a region associated with a wakeup signal (“wakeup signal region”) to at least one terminal device. In some embodiments, this may enable to provide a wakeup signal for example also in configurations with non-terrestrial networks with a reduced impact to energy consumption e.g. of the at least one terminal device and with reduced resource reservation at a network side.

In some embodiments, the first information may for example comprise at least one of the following aspects: a) the region associated with the wakeup signal (WUS), i.e. the wakeup signal region, b) a WUS configuration, which may for example comprise a WUS configuration ID and/or other configuration elements associated with at least one of the WUS and the WUS region. In other words, in some embodiments, the first information may e.g. comprise the WUS region. In some other embodiments, the first information may e.g. comprise the WUS configuration. In still some other embodiments, the first information may e.g. comprise the WUS region and the WUS configuration.

In some embodiments, the apparatus may be an apparatus for a wireless communications system.

In some embodiments, the apparatus or its functionality, respectively, may be provided in a network device, for example network node, of the communications system, for example in a base station, e.g. gNodeB (gNB).

In some embodiments, the apparatus according to the embodiments or its functionality, respectively, may be used for or within wireless communications systems, e.g. networks, based on or at least partially adhering to third generation partnership project, 3GPP, radio standards such as 5G (fifth generation) or other radio access technology.

In some embodiments, the instructions, when executed by the at least one processor, further cause the network device to determine the first information based on at least one of: a) position information reported by the at least one terminal device, e.g. obtained from a Global Navigation Satellite System (GNSS), b) a footprint of at least one terrestrial radio cell (e.g., in some embodiments a list of terrestrial network radio cell footprints), at least one tracking area mapped to the region associated with the wakeup signal.

In other words, in some embodiments, the network device may assign the region associated with the wakeup signal (“WUS region”) e.g. as Geo-Location-area, e.g. defined by GNSS, for example GPS, coordinates, for example of a boundary of the region and/or by a mapping of a list of terrestrial network cell-IDs.

In some embodiments, the first information is transmitted prior to a radio resource control, RRC, connection release according to some accepted standards, or together with, e.g. within, the RRC connection release.

In some embodiments, the terminal device may verify whether it is still in the same region associated with the wakeup signal (WUS region), for example by any of the following exemplary approaches: a) comparing its, e.g. GNSS based, location information or based on identified terrestrial network cells, b) the terminal device may decide on whether it has changed location or not based on a tracking area or tracking area list associated with region. In some embodiments, the terminal device may decide to monitor based on change of tracking area list configured for WUS region. As an example, in this approach, the terminal device need not rely on GNSS information to decide on monitoring wake up signal.

In some embodiments, the terminal device may also use a wakeup signal (WUS) configuration-ID, which, in some embodiments, may e.g. be included in a Master-Information-Block (MIB) according to some accepted standard, e.g. to decide on a change of the WUS region, e.g. with respect to a last, i.e. preceding, paging occasion.

In some embodiments, if the wakeup signal region (WUS region) is not changed, the terminal device may continue to monitor a wakeup signal, e.g. in a current cell associated with a non-terrestrial network.

In some embodiments, if the WUS region is changed, the terminal device may e.g. monitor a paging directly or may monitor for wakeup signal assigned for mobility if it is configured in a new cell.

In some embodiments, the terminal device may continue to monitor for a wakeup signal based on a determination of low mobility, for example with reference to a last known terrestrial network signal reference (e.g. radio cell of a terrestrial network, “TN cell”), which may e.g. be from fixed base station nodes.

In some embodiments, alternative or additionally to at least temporarily monitoring a wakeup signal, a terminal device may use a “Go To Sleep” (GTS) signal. In other words, in some embodiments, the terminal device may at least temporarily monitor a GTS signal. As an example, with the GTS signal, the terminal device may, for example always, monitor a downlink control channel, for example a physical downlink control channel, PDCCH, according to some accepted standard, for example unless the GTS signal is detected. In some embodiments, this can prevent potential error cases where the terminal device is no longer in the right area but it is still monitoring for the WUS (e.g. in case of GNSS, e.g. GPS, inaccuracy and/or wrong determination of a reference cell).

In other words, in some embodiments, there may be different types of power saving signal, e.g. WUS and/or GTS signal, for example depending on whether a radio cell is moving (e.g., forming part of a non-terrestrial network) or fixed (e.g., forming part of a terrestrial network).

In some embodiments, the instructions, when executed by the at least one processor, further cause the network device to modify the region associated with the wakeup signal to obtain a modified region and to transmit a second information characterizing the modified region to the at least one terminal device. This way, in some embodiments, the at least one terminal device may be notified on a change in the WUS region, which may increase operational flexibility.

In some embodiments, the instructions, when executed by the at least one processor, further cause the network device to determine when at least one non-terrestrial radio cell is at least partly covering the region associated with a wakeup signal. In some embodiments, based on the determination when (or that) at least one non-terrestrial radio cell is at least partly covering the region associated with a wakeup signal, the network device may modify the region associated with the wakeup signal to obtain the modified region and may transmit the second information characterizing the modified region to the at least one terminal device. This way, the at least one terminal device may e.g. be informed on a change in the WUS region e.g. caused by temporary availability of a radio cell, e.g. as provided by a non-terrestrial network device.

In some embodiments, one or more of the abovementioned exemplary embodiments may be used to provide a concept, e.g. “Concept 1”, for configuration of a WUS region, e.g. based on one or more parameters which are not affected by cell mobility. In some embodiments, in Concept 1, e.g. stationary terminal devices may be enabled in e.g. moving cell scenario to continue to monitor a WUS signal, for example even though there is a cell reselection, e.g. in an idle mode, e.g. according to some accepted standard. In some embodiments, for this purpose of Concept 1, the WUS region may be defined, which is for example not affected by cell mobility. In some embodiments, this may improve an operational flexibility and/or energy saving potential for example on a side of the terminal device, e.g. as compared to some conventional approaches where UE disable WUS reception on a cell change.

In the following, further exemplary embodiments are disclosed which may be used to provide a further concept, e.g. “Concept 2”, e.g. for extending WUS applicability after mobility of a terminal device outside the WUS region.

In some embodiments, the instructions, when executed by the at least one processor, further cause the network device to transmit a third information characterizing at least two wakeup signal groups and a respective paging probability associated with a respective one of the at least two wakeup signals groups to the at least one terminal device. In some embodiments, the third information may e.g. comprise two wakeup signal groups, and for example a first paging probability associated with a first wakeup signal group of the two wakeup signal groups and a second paging probability associated with a second wakeup signal group of the two wakeup signal groups.

In some embodiments, the instructions, when executed by the at least one processor, further cause the network device to receive a paging signal, e.g. an S1 paging signal, e.g. from an evolved packet core, EPC, entity, and to transmit a group wakeup signal or wakeup signal to the at least one terminal device, e.g. based on whether the paging signal is sent in a last WUS region or outside the last WUS region.

In some embodiments, the S1 paging signal may indicate at least one of: a) a last serving WUS region, b) a first paging probability associated with the last serving WUS region, c) a second paging probability e.g. associated with at least one further WUS region.

In some embodiments, the network device may select the group wakeup signal to be transmitted to the at least one terminal device based on a cell selected for paging and the respective paging probability.

In some embodiments, the network device determines a specific WUS region for transmitting a wakeup signal to the at least one terminal device, and, optionally, the network device transmits the wakeup signal to the so determined WUS region.

In some embodiments, the network device transmits a paging signal or paging message to the at least one terminal device, e.g. after transmitting the (group) wakeup signal to the at least one terminal device.

In some embodiments, the terminal device may receive, for example via non-access stratum signaling, for example from an EPC entity, information characterizing a paging probability for a first region associated with a wakeup signal for a last serving radio cell and a paging probability for at least one further region different from the first region. In some embodiments, the terminal device may select a group wakeup signal based on the information received via the non-access stratum (NAS) signaling.

In some embodiments, for example in combination with the exemplary Concept 2 mentioned above, e.g. for enabling and/or improving an applicability of the wakeup signal e.g. for mobile terminal devices changing WUS regions, the following aspects and embodiments may be provided.

In some embodiments, the terminal device may be configured with e.g. two paging probabilities, for example for WUS mapping, in a last serving cell and in other cells, e.g. via NAS signaling, e.g. between the terminal device and e.g. an AMF (Access and Mobility Management)/MME (mobility management entity) entity according to some accepted standards. In some embodiments, a core network (CN) may send the paging probability to a radio access network (RAN), e.g. RAN device, e.g. network device, e.g. for paging over a last connected WUS region and other regions. In some embodiments, the RAN may use a paging probability to select a WUS group for WUS monitoring. In some embodiments, the terminal device may monitor at least one WUS group of e.g. several different WUS groups, e.g. based on whether it is still in a last known WUS region or in a different WUS region.

In the following, further exemplary embodiments are disclosed which may be used to provide a further concept, e.g. “Concept 3”, e.g. for reducing or minimizing system information acquisition, e.g. prior to WUS reception.

In some embodiments, the instructions, when executed by the at least one processor, further cause the network device to transmit the first information in at least one of a system information block or a master information block. In some embodiments, the first information e.g. transmitted in the system information block (or master information block) may comprise WUS-region system information, the WUS-region system information comprising at least one of: a) a WUS search space configuration, b) a paging search space configuration, c) a WUS configuration identifier.

In other words, in some embodiments, e.g. when the first information comprises the WUS configuration, the first information may be transmitted in at least one of a system information block or a master information block.

In some embodiments, e.g. for group cells within a WUS region having a same WUS and paging related configuration (for example WUS, paging search-space and PDSCH locations associated with PDCCH for paging, paging occasion (PO) configurations, discontinuous reception (DRX) cycles), the network side may assign an identifier which can e.g. fit into a few reserved bits e.g. of a Master Information block, e.g. according to some accepted standard. In some embodiments, for example all, cells of a non-terrestrial network, which are covering the same WUS region, are configured with same system information parameters, and a WUS configuration-ID or region-ID of e.g. few bits is assigned to a terminal device, e.g. UE. In some embodiments, a Master Information block may include the WUS configuration-ID. In some embodiments, if the WUS configuration-ID is same as the last serving cell WUS configuration-ID, the terminal device may e.g. monitor the WUS signal directly, e.g. using a last known WUS configuration, thus avoiding reading system information prior to WUS reception.

Some embodiments relate to a method comprising:
transmitting, by a network device, a first information characterizing a region associated with a wakeup signal to at least one terminal device.

Some embodiments relate to an apparatus comprising means for causing a network device to transmit a first information characterizing a region associated with a wakeup signal to at least one terminal device.

Some embodiments relate to an apparatus, comprising at least one processor, and at least one memory storing instructions, the at least one memory and the instructions configured to, with the at least one processor, cause a terminal device to receive at least one of a first information characterizing a region associated with a wakeup signal from a network device and a second information characterizing a modified region.

In some embodiments, the apparatus may be an apparatus for a wireless communications system.

In some embodiments, the apparatus or its functionality, respectively, may be provided in a terminal device, for example user equipment (UE), of the communications system.

In some embodiments, the apparatus according to the embodiments or its functionality, respectively, may be used for or within wireless communications systems, e.g. networks, based on or at least partially adhering to third generation partnership project, 3GPP, radio standards such as 5G (fifth generation) or other radio access technology.

In some embodiments, the instructions, when executed by the at least one processor, further cause the terminal device to determine whether to monitor a wakeup signal based on the first information.

In some embodiments, the instructions, when executed by the at least one processor, further cause the terminal device to receive non-access stratum signaling characterizing a paging probability for a first region associated with a wakeup signal for a last serving radio cell and a paging probability for at least one further region different from the first region, to receive a third information characterizing at least two wakeup signal groups and a respective paging probability associated with a respective one of the at least two wakeup signal groups, and to select a group wakeup signal, e.g. for monitoring, based on the non-access stratum signaling.

Some embodiments relate to a method comprising: receiving, by a terminal device, at least one of a first information characterizing a region associated with a wakeup signal from a network device and a second information characterizing a modified region.

Some embodiments relate to an apparatus comprising means for causing a terminal device to receive at least one of a first information characterizing a region associated with a wakeup signal from a network device and a second information characterizing a modified region.

Some embodiments relate to a wireless communications system comprising at least one apparatus according to the embodiments.

### BRIEF DESCRIPTION OF THE FIGURES

FIG. 1 schematically depicts a simplified block diagram of an apparatus according to some embodiments,

FIG. 2 schematically depicts a simplified block diagram of an apparatus according to some embodiments,

FIG. 3 schematically depicts a simplified block diagram according to some embodiments,

FIG. 4 schematically depicts a simplified flow chart according to some embodiments,

FIG. 5 schematically depicts a simplified flow chart according to some embodiments,

FIG. 6 schematically depicts a simplified flow chart according to some embodiments,

FIG. 7 schematically depicts a simplified flow chart according to some embodiments,

FIG. 8 schematically depicts a simplified flow chart according to some embodiments,

FIG. 9 schematically depicts a simplified flow chart according to some embodiments,

FIG. 10 schematically depicts a signaling diagram according to some embodiments,

FIG. 11 schematically depicts a signaling diagram according to some embodiments,

FIG. 12 schematically depicts a signaling diagram according to some embodiments,

FIG. 13 schematically depicts a simplified block diagram according to some embodiments,

FIG. 14 schematically depicts a simplified block diagram according to some embodiments.

### DESCRIPTION OF SOME EXEMPLARY EMBODIMENTS

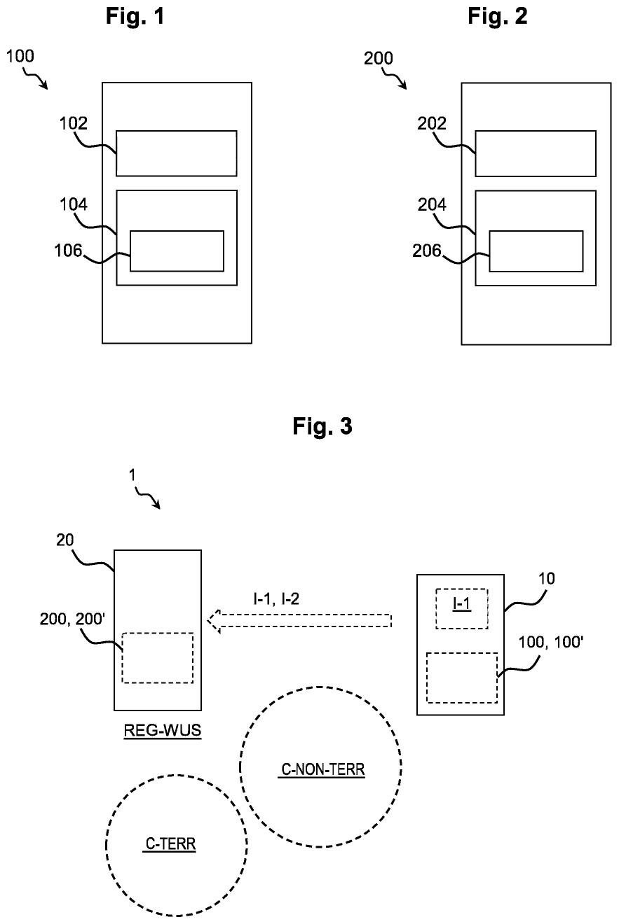

Some exemplary embodiments, see for example FIG. 1, 3, 4, relate to an apparatus 100, comprising at least one processor 102, and at least one memory 104 storing instructions 106, the at least one memory 104 and the instructions 106 configured to, with the at least one processor 102, cause a network device 10 (FIG. 3) to transmit 302 a first information I-1 characterizing a region REG-WUS associated with a wakeup signal (“wakeup signal region”) to at least one terminal device 20. In some embodiments, this may enable to provide a wakeup signal for example also in configurations with non-terrestrial networks with a reduced impact to energy consumption e.g. of the at least one terminal device 20 and with reduced resource reservation at a network side.

In some embodiments, the first information I-1 may for example comprise at least one of the following aspects: a) the region REG-WUS associated with the wakeup signal (WUS), i.e. the wakeup signal region, b) a WUS configuration, which may for example comprise a WUS configuration ID and/or other configuration elements associated with at least one of the WUS and the WUS region REG-WUS.

In other words, in some embodiments, the first information I-1 may e.g. comprise the WUS region. In some other embodiments, the first information I-1 may e.g. comprise the WUS configuration. In still some other embodiments, the first information I-1 may e.g. comprise the WUS region REG-WUS and the WUS configuration.

In some embodiments, the apparatus 100 may be an apparatus for a wireless communications system 1 (FIG. 3), e.g. for use within terrestrial and/or non-terrestrial networks.

In some embodiments, the apparatus 100 or its functionality, respectively, may be provided in a network device 10, for example network node, of the communications system, for example in a base station, e.g. gNodeB (gNB) 10.

In some embodiments, the apparatus 100 according to the embodiments or its functionality, respectively, may be used for or within wireless communications systems 1, e.g. networks, based on or at least partially adhering to third generation partnership project, 3GPP, radio standards such as 5G (fifth generation) or other radio access technology.

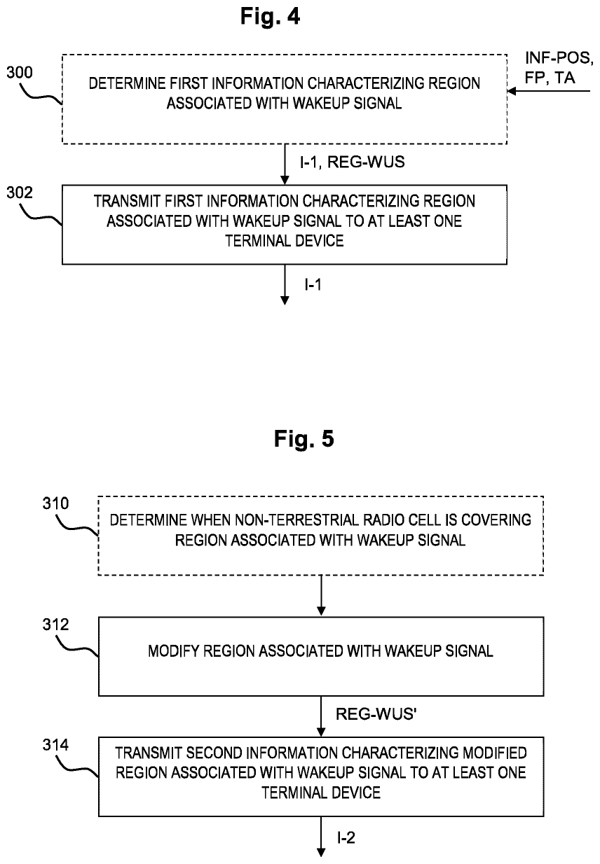

In some embodiments, the instructions 106 (FIG. 1), when executed by the at least one processor 102, further cause the network device 10 to determine 300 (FIG. 4) the first information I-1 based on at least one of: a) position information INF-POS, e.g. reported by the at least one terminal device 20, e.g. obtained from a Global Navigation Satellite System (GNSS, not shown), b) a footprint FP of at least one terrestrial radio cell C-TERR (FIG. 3) (e.g., in some embodiments a list of terrestrial network radio cell footprints FP), at least one tracking area TA mapped to the region (REG-WUS) associated with the wakeup signal.

In other words, in some embodiments, the network device 10 may assign the region REG-WUS associated with the wakeup signal (“WUS region”) e.g. as Geo-Location-area, e.g. defined by GNSS, for example GPS, coordinates, for example of a boundary of the region and/or by a mapping of a list of terrestrial network cell-IDs.

In some embodiments, the first information I-1 is transmitted prior to a radio resource control, RRC, connection release according to some accepted standards, or together with, e.g. within, the RRC connection release.

In some embodiments, the terminal device 20 may verify whether it is still in the same region REG-WUS associated with the wakeup signal (WUS region), for example by any of the following exemplary approaches: a) comparing its, e.g. GNSS based, location information or based on identified terrestrial network cells C-TERR, b) the terminal device 20 may decide on whether it has changed location or not based on a tracking area or tracking area list associated with region REG-WUS. In some embodiments, the terminal device 20 may decide to monitor based on change of tracking area list configured for WUS region. As an example, in this approach, the terminal device 20 need not rely on GNSS information to decide on monitoring a wake up signal.

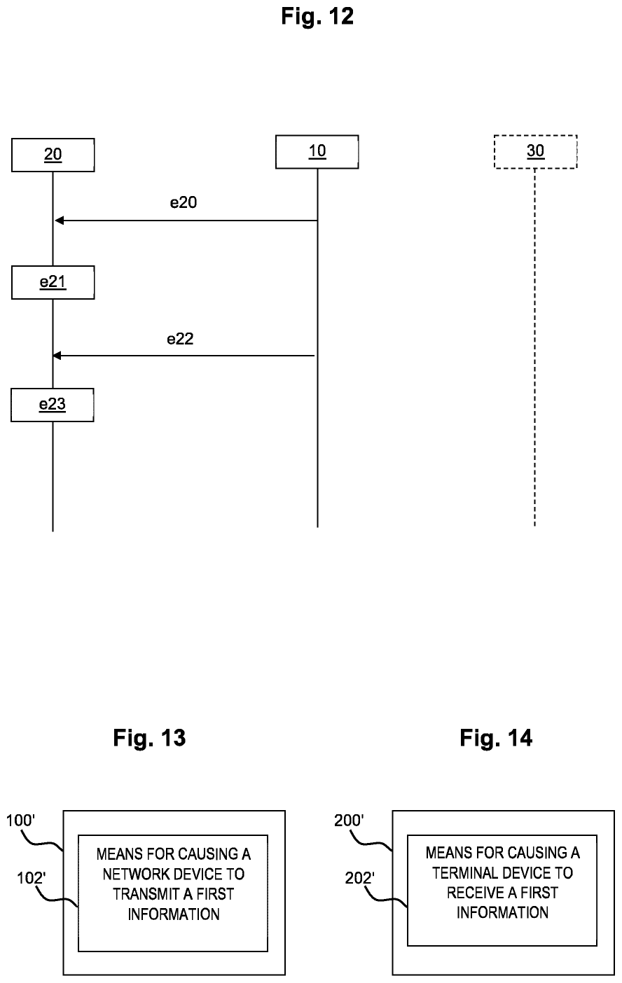

In some embodiments, the terminal device 20 may also use a wakeup signal (WUS) configuration-ID, which, in some embodiments, may e.g. be included in a Master-Information-Block (MIB) according to some accepted standard, e.g. to decide on a change of the WUS region, e.g. with respect to a last, i.e. preceding, paging occasion. Further details regarding this exemplary embodiment are provided further below with reference to FIG. 12.

In some embodiments, if the wakeup signal region (WUS region) is not changed, the terminal device 20 may continue to monitor a wakeup signal, e.g. in a current cell associated with a non-terrestrial network C-NON-TERR.

In some embodiments, if the WUS region is changed, the terminal device 20 may e.g. monitor a paging directly or may monitor for wakeup signal assigned for mobility if it is configured in a new cell. I.e., in other words, the terminal device 20 is configured to monitor for a wakeup signal, e.g. assigned for mobility, e.g. if it is configured in a new cell.

In some embodiments, the terminal device 20 may continue to monitor for a wakeup signal based on a determination of low mobility, for example with reference to a last known terrestrial network signal reference (e.g. radio cell C-TERR of a terrestrial network, “TN cell”), which may e.g. be from fixed base station nodes.

In some embodiments, alternative or additionally to at least temporarily monitoring a wakeup signal, a terminal device 20 may use a “Go To Sleep” (GTS) signal. In other words, in some embodiments, the terminal device 20 may at least temporarily monitor a GTS signal. As an example, with the GTS signal, the terminal device 20 may, for example always, monitor a downlink control channel, for example a physical downlink control channel, PDCCH, according to some accepted standard, for example unless the GTS signal is detected. In some embodiments, this can prevent potential error cases where the terminal device 20 is no longer in the right area but it is still monitoring for the WUS (e.g. in case of GNSS, e.g. GPS, inaccuracy and/or wrong determination of a reference cell).

In other words, in some embodiments, there may be different types of power saving signal, e.g. WUS and/or GTS signal, for example depending on whether a radio cell C-TERR, C-NON-TERR is moving (e.g., forming part of a non-terrestrial network) or fixed (e.g., forming part of a terrestrial network).

In some embodiments, FIG. 5, the instructions 106, when executed by the at least one processor 102, further cause the network device 10 to modify the region REG-WUS associated with the wakeup signal to obtain a modified region REG-WUS' and to transmit a second information I-2 characterizing the modified region REG-WUS' to the at least one terminal device 20. This way, in some embodiments, the at least one terminal device 20 may be notified on a change in the WUS region REG-WUS, which may increase operational flexibility.

In some embodiments, FIG. 5, the instructions 106, when executed by the at least one processor 102, further cause the network device 10 to determine 310 when at least one non-terrestrial radio cell C-NON-TERR is at least partly covering the region REG-WUS associated with a wakeup signal. In some embodiments, based on the determination 310 when (or that) at least one non-terrestrial radio cell C-NON-TERR is at least partly covering the region REG-WUS associated with a wakeup signal, the network device 10 may modify 312 the region REG-WUS associated with the wakeup signal to obtain the modified region REG-WUS' and may transmit 314 the second information I-2 characterizing the modified region REG-WUS' to the at least one terminal device 20. This way, the at least one terminal device 20 may e.g. be informed on a change in the WUS region REG-WUS, e.g. caused by temporary availability of a radio cell C-NON-TERR, e.g. as provided by a non-terrestrial network device.

In some embodiments, one or more of the abovementioned exemplary embodiments may be used to provide a concept, e.g. “Concept 1”, for configuration of a WUS region REG-WUS, e.g. based on one or more parameters which are not affected by cell mobility. In some embodiments, in Concept 1, e.g. stationary terminal devices 20 may be enabled in e.g. moving cell scenario to continue to monitor a WUS signal, for example even though there is a cell reselection, e.g. in an idle mode, e.g. according to some accepted standard. In some embodiments, for this purpose of Concept 1, the WUS region REG-WUS may be defined, which is for example not affected by cell mobility. In some embodiments, this may improve an operational flexibility and/or energy saving potential for example on a side of the terminal device 20, e.g. as compared to some conventional approaches where a UE disable WUS reception on a cell change.

In the following, further exemplary embodiments are disclosed which may be used to provide a further concept, e.g. “Concept 2”, e.g. for extending WUS applicability after mobility of a terminal device 20 outside the WUS region REG-WUS.

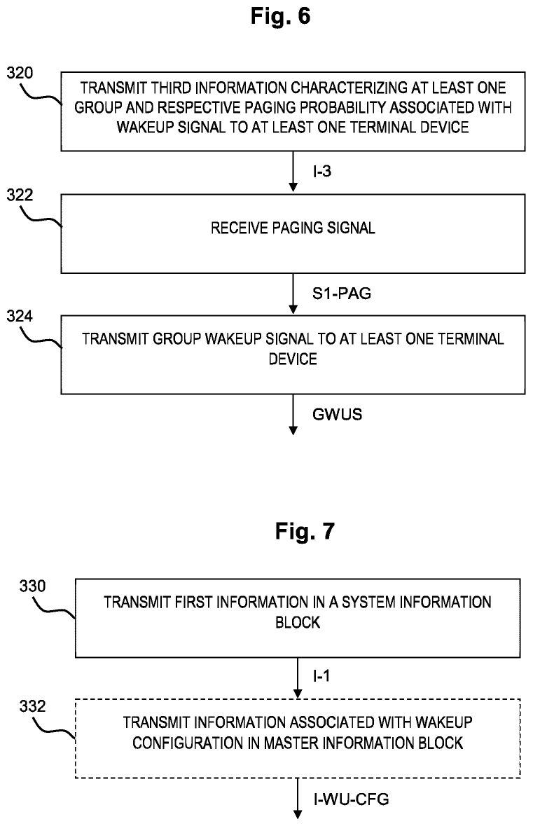

In some embodiments, FIG. 6, the instructions 106, when executed by the at least one processor 102, further cause the network device 10 to transmit 320 a third information I-3 characterizing at least two wakeup signal groups and a respective paging probability associated with a respective one of the at least two wakeup signal groups to the at least one terminal device 20. In some embodiments, the third information I-3 may may e.g. comprise two wakeup signal groups, and for example a first paging probability associated with a first wakeup signal group of the two wakeup signal groups and a second paging probability associated with a second wakeup signal group of the two wakeup signal groups.

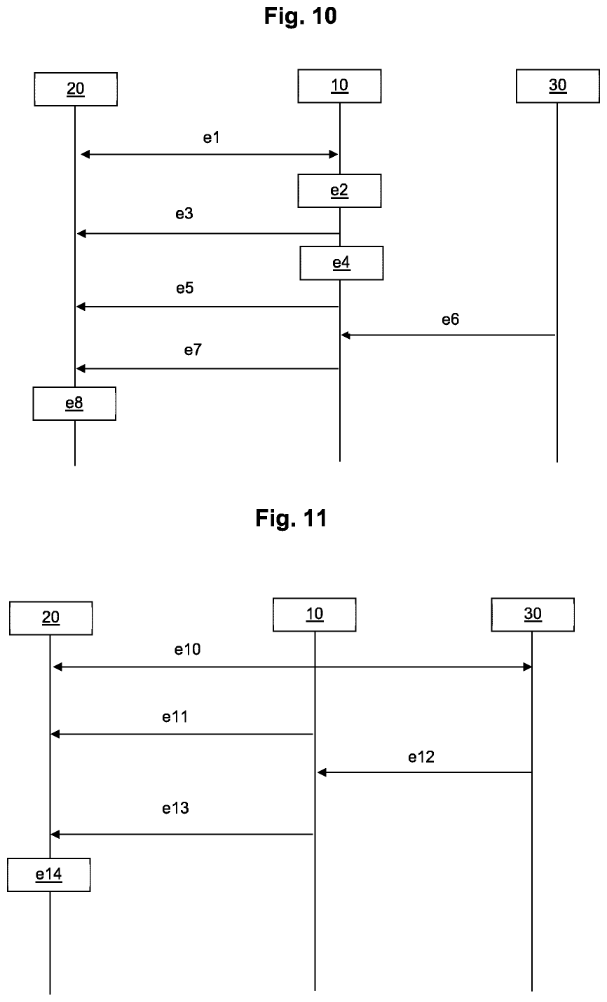

In some embodiments, the instructions 106, when executed by the at least one processor 102, further cause the network device 10 to receive 322 a paging signal S1-PAG, e.g. an S1 paging signal (also see, for example, element e6 of FIG. 10), e.g. from an evolved packet core, EPC, entity (see for example element 30 of FIG. 12), and to transmit 324 (FIG. 6) a group wakeup signal GWUS (or a wakeup signal, in some embodiments) to the at least one terminal device 20, e.g. based on whether the paging signal is sent in a last WUS region or outside the last WUS region.

In some embodiments, the S1 paging signal S1-PAG may indicate at least one of: a) a last serving WUS region, b) a first paging probability, c) a second paging probability.

In some embodiments, the network device 10 may select the group wakeup signal GWUS to be transmitted to the at least one terminal device 20 based on a cell selected for paging and the respective paging probability.

In some embodiments, the network device 10 determines a specific WUS region REG-WUS for transmitting a wakeup signal to the at least one terminal device 20, and, optionally, the network device 10 transmits the wakeup signal to the so determined WUS region REG-WUS.

In some embodiments, the terminal device 20 may receive, for example via non-access stratum signaling, for example from an EPC entity, information characterizing a paging probability for a first region associated with a wakeup signal for a last serving radio cell and a paging probability for at least one further region different from the first region. In some embodiments, the terminal device may select a group wakeup signal GWUS based on the information received via the non-access stratum (NAS) signaling.

In some embodiments, for example in combination with the exemplary Concept 2 mentioned above, e.g. for enabling and/or improving an applicability of the wakeup signal e.g. for mobile terminal devices 20 changing WUS regions REG-WUS, the following aspects and embodiments may be provided.

In some embodiments, the terminal device 20 may be configured with e.g. two paging probabilities, for example for WUS mapping, in a last serving cell and in other cells, e.g. via NAS signaling, e.g. between the terminal device 20 and e.g. an AMF (Access and Mobility Management)/MME (mobility management entity) entity (see for example element 30 of FIG. 12) according to some accepted standards. In some embodiments, a core network (CN) may send the paging probability to a radio access network (RAN), e.g. RAN device, e.g. network device 10, e.g. for paging over a last connected WUS region and other regions. In some embodiments, the RAN may use a paging probability to select a WUS group for WUS monitoring. In some embodiments, the terminal device 20 may monitor at least one WUS group of e.g. several different WUS groups, e.g. based on whether it is still in a last known WUS region or in a different WUS region.

In the following, further exemplary embodiments are disclosed which may be used to provide a further concept, e.g. “Concept 3”, e.g. for reducing or minimizing system information acquisition, e.g. prior to WUS reception.

In some embodiments, FIG. 7, the instructions 106, when executed by the at least one processor 102, further cause the network device 10 to transmit 330 the first information I-1 in at least one of a system information block or a master information block. In some embodiments, the first information I-1 e.g. transmitted in the system information block (or master information block) may comprise WUS-region system information, the WUS-region system information comprising at least one of: a) a WUS search space configuration, b) a paging search space configuration, c) a WUS configuration identifier.

In other words, in some embodiments, e.g. when the first information I-1 comprises the WUS configuration, the first information I-1 may be transmitted in at least one of a system information block or a master information block.

In some embodiments, e.g. for group cells within a WUS region REG-WUS having a same WUS and paging related configuration (for example WUS, paging search-space and PDSCH locations associated with PDCCH for paging, paging occasion (PO) configurations, discontinuous reception (DRX) cycles), the network side may assign an identifier which can e.g. fit into a few reserved bits e.g. of a Master Information block, e.g. according to some accepted standard. In some embodiments, for example all, cells of a non-terrestrial network, which are at least partly covering the same WUS region REG-WUS, are configured with same system information parameters, and a WUS configuration-ID or region-ID of e.g. few bits is assigned to a terminal device, e.g. UE 20. In some embodiments, a Master Information block may include the WUS configuration-ID. In some embodiments, if the WUS configuration-ID is same as the last serving cell WUS configuration-ID, the terminal device may e.g. monitor the WUS signal directly, e.g. using a last known WUS configuration, thus avoiding reading system information prior to WUS reception. As an example, in some embodiments, the network device 10 may transmit information I-WU-CFG associated with a wakeup configuration in a Master Information Block, see block 332 of FIG. 7.

Some embodiments, FIG. 4, relate to a method comprising: transmitting 302, by a network device 10, a first information I-1 characterizing a region REG-WUS associated with a wakeup signal to at least one terminal device 20.

Some embodiments, FIG. 13, relate to an apparatus 100′ comprising means 102′ for causing a network device 10 to transmit 302 a first information I-1 characterizing a region REG-WUS associated with a wakeup signal to at least one terminal device. In some embodiments, the means 102′ may e.g. comprise at least one processor 102, and at least one memory 104 storing instructions 106 for causing the network device 10 to transmit 302 the first information I-1.

Some embodiments, FIG. 2, 3, 7, relate to an apparatus 200, comprising at least one processor 202, and at least one memory 204 storing instructions 206, the at least one memory 204 and the instructions 206 configured to, with the at least one processor 202, cause a terminal device 20 to receive at least one of a first information I-1 characterizing a region REG-WUS associated with a wakeup signal from a network device 10 and a second information I-2 characterizing a modified region REG-WUS′.

In some embodiments, the apparatus 200 may be an apparatus for a wireless communications system 1.

In some embodiments, the apparatus 200 or its functionality, respectively, may be provided in a terminal device 20, for example user equipment (UE) 20, of the communications system 1.

In some embodiments, the apparatus 200 according to the embodiments or its functionality, respectively, may be used for or within wireless communications systems, e.g. networks, based on or at least partially adhering to third generation partnership project, 3GPP, radio standards such as 5G (fifth generation) or other radio access technology.

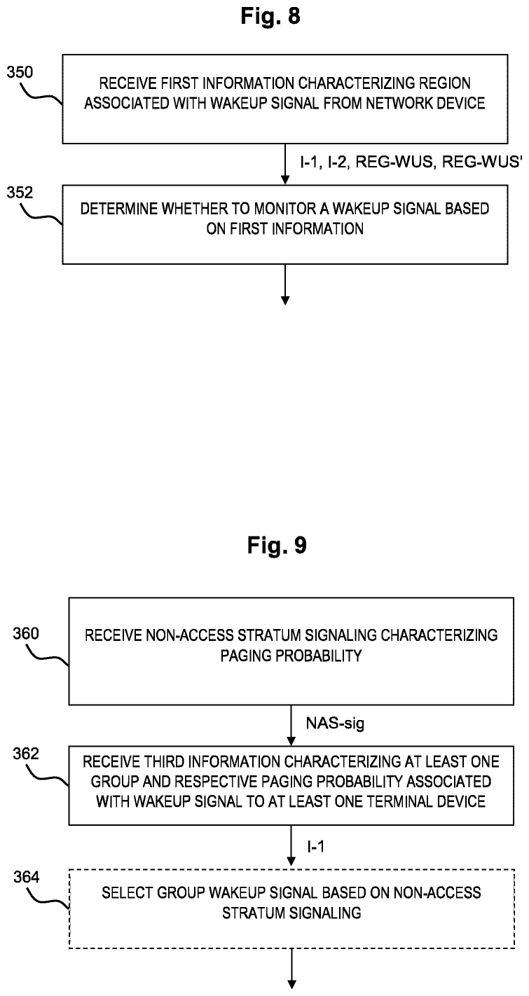

In some embodiments, FIG. 8, the instructions 206, when executed by the at least one processor, further cause the terminal device 20 to determine 352 whether to monitor a wakeup signal based on the first information I-1.

In some embodiments, as mentioned above, the terminal device 20 may verify whether it is still in the same region REG-WUS associated with the wakeup signal (WUS region), for example by any of the following exemplary approaches: a) comparing its, e.g. GNSS based, location information or based on identified terrestrial network cells, b) the terminal device 20 may decide on whether it has changed location or not based on a tracking area or tracking area list associated with region. In some embodiments, the terminal device 20 may decide to monitor based on change of tracking area list configured for WUS region. As an example, in this approach, the terminal device 20 need not rely on GNSS information to decide on monitoring the wake up signal.

In some embodiments, FIG. 9, the instructions 206, when executed by the at least one processor 202, further cause the terminal device 20 to receive 360 non-access stratum signaling NAS-sig characterizing a paging probability for a first region associated with a wakeup signal for a last serving radio cell and a paging probability for at least one further region different from the first region, to receive 362 a third information I-3 characterizing at least two wakeup signal groups and a respective paging probability associated with a respective one of the at least two wakeup signals groups, and, optionally, to select 364 a group wakeup signal, e.g. for monitoring, based on the non-access stratum signaling.

Some embodiments, FIG. 8, relate to a method comprising: receiving 350, by a terminal device 20, at least one of a first information I-1 characterizing a region REG-WUS associated with a wakeup signal from a network device and a second information I-2 characterizing a modified region REG-WUS′.

Some embodiments, FIG. 14, relate to an apparatus 200′ comprising means 202′ for causing a terminal device 20 to receive 350 at least one of a first information I-1 characterizing a region associated with a wakeup signal from a network device and a second information I-2 characterizing a modified region. In some embodiments, the means 202′ may e.g. comprise at least one processor 202, and at least one memory 204 storing instructions 206 for causing the terminal device 20 to receive 350 the first information I-1 and/or the second information I-2.

Some embodiments, FIG. 3, relate to a wireless communications system 1 comprising at least one apparatus 100, 100′, 200, 200′ according to the embodiments.

FIG. 10 schematically depicts a signaling diagram according to some embodiments. Element e1 symbolizes an RRC connection between the network device, e.g. gNB, 10 and the terminal device, e.g. UE, 20. Element e2 symbolizes the RAN, e.g. via gNB 10, determining a WUS region, e.g. based on GNSS information and/or a list of radio cell footprints of terrestrial radio cells, as e.g. reported by the UE 20. Element e3 symbolizes the gNB transmitting an RRC Connection Release message to the UE 10, the RRC Connection Release message comprising the first information I-1. Element e4 symbolizes the gNB 10 modifying the WUS region, e.g. when at least one non-terrestrial node radio cell is at least partly covering the WUS region REG-WUS, and element e5 symbolizes the gNB transmitting the modified WUS region REG-WUS' to the UE 20, e.g. as part of system information. Element e6 symbolizes the gNB receiving a paging signal associated with the last serving WUS region, e.g. from an EPC entity 30, and element e7 symbolizes the gNB 10 transmitting a wakeup signal. Element e8 symbolizes the UE 20 checking the WUS region, and, optionally, deciding to monitor for paging.

FIG. 11 schematically depicts a signaling diagram according to some embodiments. Element e10 symbolizes the UE receiving NAS signaling from the EPC entity 30, e.g. characterizing an assignment of a paging probability for a last serving WUS region and of a paging probability for another region. Element e11 symbolizes the gNB transmitting system information to the UE, e.g. comprising a group wakeup signal (GWUS) configuration. In some embodiments, the GWUS configuration may characterize a first WUS group and an associated paging probability range of e.g. (0-0.3), and a second WUS group and an associated paging probability range of e.g. (0.3-1). Element e12 symbolizes the gNB 10 receiving a paging signal, e.g. S1-paging, associated with the last serving WUS region, e.g. from the EPC entity 30, the paging signal characterizing the last serving WUS region, a first paging probability and a second paging probability. Element e13 symbolizes the gNB 10 transmitting a group wakeup signal to the UE 20, e.g. selected based on a cell selected for paging and on the associated paging probability. Element e14 symbolizes the UE selecting the group wakeup signal based on the information received via the NAS signaling e10.

FIG. 12 schematically depicts a simplified block diagram according to some embodiments. Element e20 symbolizes the gNB 10 transmitting a system information block to the UE 20, the system information block e.g. characterizing at least one of: WUS-region system information, the WUS-region system information comprising at least one of: a) a WUS search space configuration, b) a paging search space configuration, c) a WUS configuration identifier. Element e21 symbolizes the UE obtaining WUS region specific information in a last serving cell. Element e22 symbolizes the gNB 10 transmitting a Master-Information-Block e.g. comprising the WUS configuration identifier and a Value-Tag to the UE. Element e23 symbolizes the UE, for example only, checking the Master-Information-Block, e.g. before a reception of a wakeup signal. In some embodiments, the approach of FIG. 13 enables an efficient configuration of common WUS specific parameters, e.g. for group of cells, and indication of this configuration-ID in the master information block, e.g. to minimize a system info acquisition prior to WUS reception.

In some embodiments, the principle according to the embodiments may be used to enable a WUS applicability for NTN (non-terrestrial network) scenarios, e.g. with minimum impact to UE energy consumption and reduced resource reservation at network.

In some embodiments, the network device 10 is configured to perform aspects of at least one of the blocks 320, 322, 324 as exemplarily depicted by FIG. 6, for example without transmitting the first information I-1, e.g. according to block 302 of FIG. 4. In other words, in some embodiments, the network device may be configured to transmit a WUS configuration, which may for example comprise a WUS configuration ID and/or other configuration elements associated with at least one of the WUS and the WUS region, to the at least one terminal device 20, e.g. within at least one of a master information block and a system information block.

In some embodiments, the network device 10 is configured to perform aspects of at least one of the blocks 330, 332 as exemplarily depicted by FIG. 7, for example without transmitting the first information I-1, e.g. according to block 302 of FIG. 4. In other words, in some embodiments, the network device 10 may be configured to transmit 330 the first information I-1 in at least one of a system information block or a master information block. In other words, in some embodiments, the network device 10 may be configured to transmit 332 the information I-WU-CFG associated with the wakeup configuration in at least one of a system information block or a master information block, for example without transmitting the first information I-1, e.g. according to block 302 of FIG. 4.

In some embodiments, the terminal device 20 is configured to perform aspects of at least one of the blocks 360, 362, 364 as exemplarily depicted by FIG. 9, for example without receiving the first information I-1, e.g. according to block 350 of FIG. 8. In other words, in some embodiments, the terminal device 20 may be configured to receive the WUS configuration, e.g. from the network device 10, e.g. within at least one of a master information block and a system information block.

1-15. (canceled)

16. An apparatus, comprising at least one processor, and at least one memory storing instructions, the at least one memory and the instructions configured to, with the at least one processor, cause a network device to transmit a first information (I-1) characterizing a region (REG-WUS) associated with a wakeup signal to at least one terminal device.

17. The apparatus according to claim 16, wherein the instructions, when executed by the at least one processor, further cause the network device to determine the first information (I-1) based on at least one of: a) position information (INF-POS) reported by the at least one terminal device, b) a footprint (FP) of at least one terrestrial radio cell (C-TERR), c) at least one tracking area (TA) mapped to the region (REG-WUS) associated with the wakeup signal.

18. The apparatus according to claim 16, wherein the instructions, when executed by the at least one processor, further cause the network device to modify the region (REG-WUS) associated with the wakeup signal to obtain a modified region (REG-WUS′) and to transmit a second information (I-2) characterizing the modified region (REG-WUS′) to the at least one terminal device.

19. The apparatus according to claim 13, wherein the instructions, when executed by the at least one processor, further cause the network device to determine (when at least one non-terrestrial radio cell (C-NON-TERR) is at least partly covering the region (REG-WUS) associated with a wakeup signal.

20. The apparatus according to claim 16, wherein the instructions, when executed by the at least one processor, further cause the network device to transmit (a third information (I-3) characterizing at least two wakeup signal groups and a respective paging probability associated with a respective one of the at least two wakeup signal groups to the at least one terminal device.

21. The apparatus (according to claim 20, wherein the instructions, when executed by the at least one processor, further cause the network device to receive (a paging signal (S1-PAG) and to transmit a group wakeup signal (GWUS) or a wakeup signal to the at least one terminal device based on whether the paging signal (S1-PAG) is sent in a last WUS region or outside the last WUS region.

22. The apparatus according to claim 16, wherein the instructions, when executed by the at least one processor, further cause the network device to transmit the first information (I-1) in at least one of a system information block or a master information block.

23. A method comprising: transmitting, by a network device, a first information (I-1) characterizing a region (REG-WUS) associated with a wakeup signal to at least one terminal device.

24. An apparatus, comprising at least one processor, and at least one memory storing instructions, the at least one memory and the instructions configured to, with the at least one processor, cause a terminal device to receive at least one of a first information (I-1) characterizing a region (REG-WUS) associated with a wakeup signal from a network device and a second information (I-1) characterizing a modified region (REG-WUS′).

25. The apparatus according to claim 24, wherein the instructions, when executed by the at least one processor, further cause the terminal device to determine whether to monitor a wakeup signal based on the first information (I-1).

26. The apparatus according to claim 24, wherein the instructions, when executed by the at least one processor, further cause the terminal device to receive non-access stratum signaling (NAS-sig) characterizing a paging probability for a first region associated with a wakeup signal for a last serving radio cell and a paging probability for at least one further region different from the first region, to receive a third information (I-3) characterizing at least two wakeup signal groups and a respective paging probability associated with a respective one of the at least two wakeup signal groups, and to select a group wakeup signal (GWUS) for monitoring based on the non-access stratum signaling (NAS-sig).

27. A method comprising: receiving, by a terminal device, at least one of a first information (I-1) characterizing a region (REG-WUS) associated with a wakeup signal from a network device and a second information (I-1) characterizing a modified region (REG-WUS′)
